(19) United States
(12) Patent Application Publication
(10) Pub. No.: US 2019/0299284 A1
(43) Pub. Date: Oct. 3, 2019

(54) DISCRETE THREE-DIMENSIONAL PRINTING METHOD

(71) Applicant: Konica Minolta Laboratory U.S.A., Inc., San Mateo, CA (US)

(72) Inventor: Jun Amano, Hillsborough, CA (US)

(73) Assignee: Konica Minolta Laboratory U.S.A., Inc., San Mateo, CA (US)

(21) Appl. No.: 15/941,123

(22) Filed: Mar. 30, 2018

(51) Int. Cl. B22F 3/00; B22F 3/20; B33Y 10/00; B33Y 50/02

(52) U.S. Cl. CPC B22F 3/008; B33Y 50/02; B33Y 10/00; B22F 3/20

(57) ABSTRACT

A method is provided for manufacturing a three-dimensional printed (3D-printed) object. The method includes: depositing first threads separated by gaps in a first run of a first layer; depositing second threads in a second run of the first layer, and the second threads fill the gaps between the first threads and create a plurality of first-layer vertical interfaces along a length of each of the first threads; depositing third threads separated by gaps in a first run of a second layer; and depositing fourth threads in a second run of the second layer, and the fourth threads fill the gaps between the third threads and create a plurality of second-layer vertical interfaces along a length of each of the third threads. The second layer is deposited on top of the first layer so that one or more of the first-layer vertical interfaces do not overlap with the second-layer vertical interfaces.

### BACKGROUND

Three-dimensional printing (3D-printing) is popular for creating a three-dimensional (3D) module of an object. 3D-printing methods utilize a nozzle of a 3D-printer to extrude, for example, a melted 3D-printing material on a substrate and continually stacking layers of the 3D-printing material on top of each other to create a 3D-printed object. Eventually, the 3D-printed material solidifies and solid layers that are stacked on top of each other and connected by interfaces (i.e., inter-layer interfaces) are formed. When stress is applied to the 3D-printed object, the inter-layer interfaces may break and cause delamination of some layers from the 3D-printed object.

### SUMMARY

In general, in one aspect, the invention relates to a method for manufacturing a three-dimensional printed (3D-printed) object, the method comprising: depositing first threads separated by gaps in a first run of a first layer; depositing second threads in a second run of the first layer, wherein the second threads fill the gaps between the first threads and create a plurality of first-layer vertical interfaces along a length of each of the first threads; depositing third threads separated by gaps in a first run of a second layer; and depositing fourth threads in a second run of the second layer, wherein the fourth threads fill the gaps between the third threads and create a plurality of second-layer vertical interfaces along a length of each of the third threads. The second layer is deposited on top of the first layer so that one or more of the first-layer vertical interfaces do not overlap with the second-layer vertical interfaces.

In general, in one aspect, the invention relates to a non-transitory computer-readable medium (CRM) storing instructions that causes a print server to perform an operation to manufacture a three-dimensional (3D) object, the operation comprising: depositing first threads separated by gaps in a first run of a first layer; depositing second threads in a second run of the first layer, wherein the second threads fill the gaps between the first threads and create a plurality of first-layer vertical interfaces along a length of each of the first threads; depositing third threads separated by gaps in a first run of a second layer; and depositing fourth threads in a second run of the second layer, wherein the fourth threads fill the gaps between the third threads and create a plurality of second-layer vertical interfaces along a length of each of the third threads. The second layer is deposited on top of the first layer so that one or more of the first-layer vertical interfaces do not overlap with the second-layer vertical interfaces.

In general, in one aspect, the invention relates to a system for three-dimensional (3D) printing of an object, the system comprising: a memory; and a computer processor connected to the memory. The computer processor causes a printing head of a 3D-printer coupled to the system to: deposit first threads separated by gaps in a first run of a first layer; deposit second threads in a second run of the first layer, wherein the second threads fill the gaps between the first threads and create a plurality of first-layer vertical interfaces along a length of each of the first threads; deposit third threads separated by gaps in a first run of a second layer; and deposit fourth threads in a second run of the second layer, wherein the fourth threads fill the gaps between the third threads and create a plurality of second-layer vertical interfaces along a length of each of the third threads. The second layer is deposited on top of the first layer so that one or more of the first-layer vertical interfaces do not overlap with the second-layer vertical interfaces.

Other aspects of the invention will be apparent from the following description and the appended claims.

### BRIEF DESCRIPTION OF DRAWINGS

FIG. 1 shows a system in accordance with one or more embodiments of the invention.

FIG. 2 shows a flowchart in accordance with one or more embodiments of the invention.

FIGS. 3A-3C show an example of a conventional 3D printing.

FIGS. 4A-4C show implementation examples in accordance with one or more embodiments of the invention.

FIG. 5 shows an implementation example in accordance with one or more embodiments of the invention.

FIG. 6 shows an implementation example in accordance with one or more embodiments of the invention.

FIG. 7 shows an implementation example in accordance with one or more embodiments of the invention.

FIG. 8A-8B show implementation examples in accordance with one or more embodiments of the invention.

FIG. 9 shows a computing system in accordance with one or more embodiments of the invention.

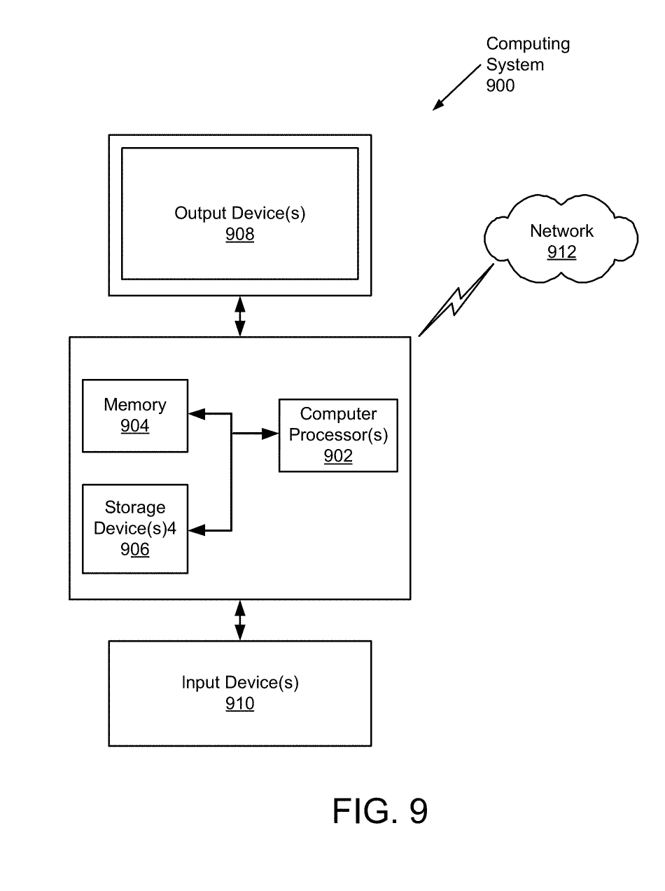

### DETAILED DESCRIPTION

Specific embodiments of the invention will now be described in detail with reference to the accompanying figures. Like elements in the various figures are denoted by like reference numerals for consistency.

In the following detailed description of embodiments of the invention, numerous specific details are set forth in order to provide a more thorough understanding of the invention. However, it will be apparent to one of ordinary skill in the art that the invention may be practiced without these specific details. In other instances, well-known features have not been described in detail to avoid unnecessarily complicating the description.

In general, embodiments of the invention provide a method, a non-transitory computer readable medium (CRM), and a system of for 3D-printing of a 3D-printed object. Specifically, for the 3D-printing of the 3D-printed object, a 3D-printing material is deposited in form of threads (i.e., wire-shaped lines of a material extruded from a printing nozzle and deposited on a surface) to form each layer of the 3D-printed object. Each layer may be formed by multiple runs (hereinafter, discrete deposition). For example, according to one or more embodiments, multiple threads may be deposited such that the ends of the threads are separated by gaps, which are then filled with new thread by additional runs. Discrete deposition of the threads in a layer creates vertical interfaces between the threads in the layer. A vertical interface is formed by contact between an end of one thread and an end of another previously deposited thread. The 3D-printed object also includes inter-layer interfaces that are defined as a contact between lengths of two adjacent threads.

In one or more embodiments of the invention, the 3D-printed object may be formed by a plurality of layers. Each layer of the 3D-printed object may include the vertical interfaces. The vertical interfaces of consecutive layers may not overlap (i.e., the vertical interfaces of two layers that are directly in contact do not connect directly).

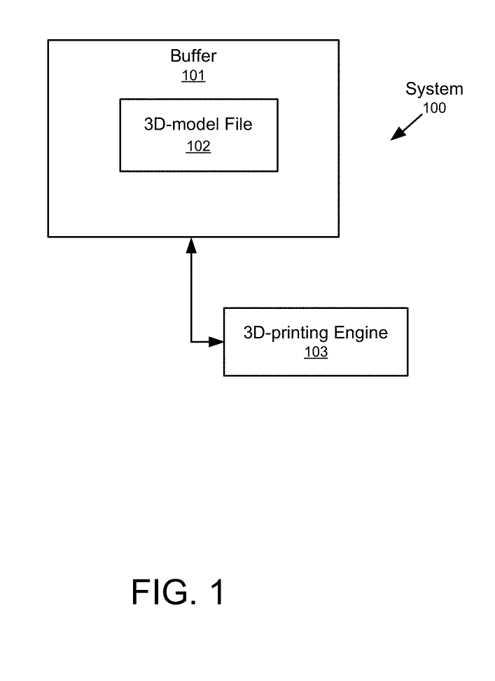

FIG. 1 shows a system (100) in accordance with one or more embodiments of the invention. As shown in FIG. 1, the system (100) has multiple components, including, for example, a buffer (101) and a 3D-printing engine (103). Each of these components (101, 103) may be located on the same computing device (e.g., personal computer (PC), laptop, tablet PC, smart phone, multifunction printer, kiosk, server, etc.) or on different computing devices connected by a network of any size having wired and/or wireless segments.

In one or more embodiments of the invention, the buffer (101) may be implemented in hardware (i.e., circuitry), software, or any combination thereof. The system (100) obtains a 3D-model file (102) of the 3D-printed object, and the buffer (101) is configured to store the 3D-model file (102). The 3D-model file (102) may be an image and/or a graphic (e.g., a stereolithogrpahy (STL) format, a virtual reality model language (VRML) format file, an additive manufacturing file (AMF) format, etc.). The 3D-model file (102) may be obtained (e.g., downloaded, created locally, etc.) from any source.

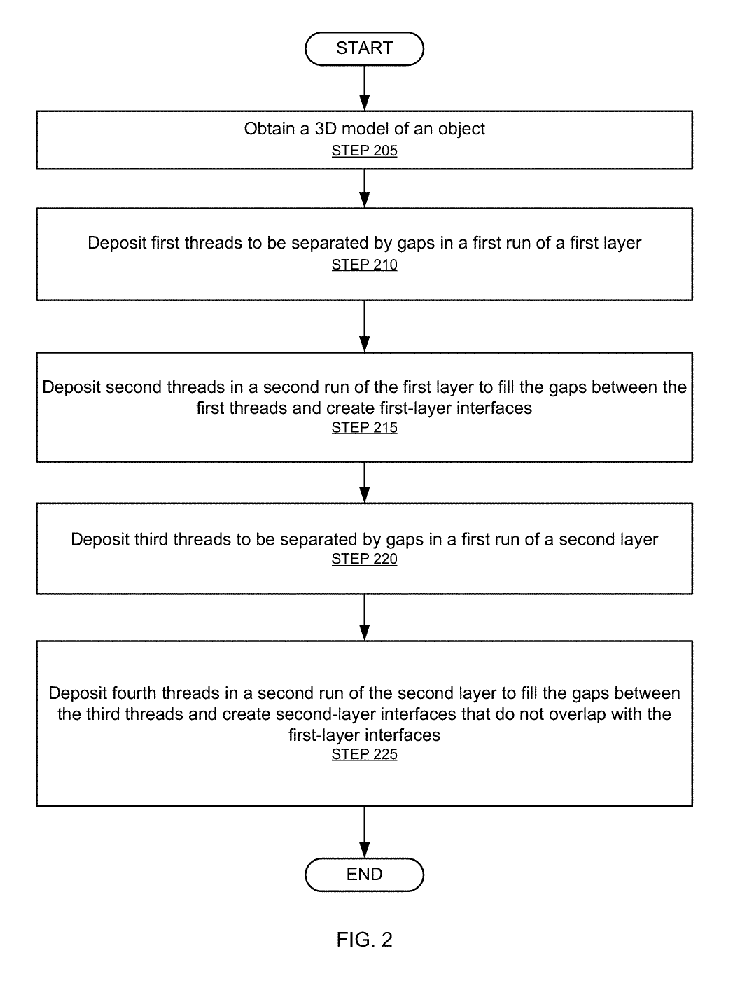

In one or more embodiments of the invention, the 3D-printing engine (103) may be implemented in hardware (i.e., circuitry), software, or any combination thereof. The 3D-printing engine (103) executes the 3D-model file (102) to print the 3D-printed object. This is exemplified in more detail below with reference to FIGS. 2, 4A-4C, 5-7, and 8A-8B.

Although the system (100) is shown as having two components (101, 103), in other embodiments of the invention, the system (100) may have more or fewer components. Further, the functionality of each component described above may be split across components. Further still, each component (101, 103) may be utilized multiple times to carry out an iterative operation.

FIG. 2 shows a flowchart in accordance with one or more embodiments of the invention. The flowchart depicts a process for manufacturing a 3D-printed object. One or more of the steps in FIG. 2 may be performed by the components of the system (100), discussed above in reference to FIG. 1. Specifically, one or more steps in FIG. 2 may be performed by the 3D-printing engine (103) as discussed above in reference to FIG. 1. In one or more embodiments of the invention, one or more of the steps shown in FIG. 2 may be omitted, repeated, and/or performed in a different order than the order shown in FIG. 2. Accordingly, the scope of the invention should not be considered limited to the specific arrangement of steps shown in FIG. 2.

Referring to FIG. 2, initially, a 3D-model file of a 3D-printed object is obtained and stored (STEP 205). For example, the system (100) may obtain the 3D-model file (102) and store it in the buffer (101). In one or more embodiments, the 3D-model file may include a 3D-schematic of the 3D-printed object, print instructions or any other parameters that are needed for 3D-printing.

In STEP 210, first threads of a material are deposited in a first run to create a first layer (i.e., the first run of the first layer). For example, in one or more embodiments, the 3D-printing engine (103) may be coupled to a printing head that can deposit the 3D-printing material on a substrate. The first run of the first layer deposits the first threads discretely in such a way that the first threads are separated by gaps. The first layer may be deposited on any other layer of the 3D-printed object or on a substrate.

In STEP 215, second threads of the material are deposited in a second run to complete the first layer (i.e., the second run of the first layer). The second threads fill the gaps between the first threads, which create vertical interfaces of the first layer (i.e., first-layer vertical interfaces). In one or more embodiments, the first-layer vertical interfaces may be a point of contact between one end of a first thread and one end of a second thread. This way, the first-layer vertical interfaces connect the first and the second threads together along a length-wise direction of the first and second threads.

In STEP 220, third threads of the material are deposited in a first run to create a second layer (i.e., the first run of the second layer). The first run of the second layer deposits the third threads discretely in such a way that the third threads are separated by gaps. The second layer may be deposited on top of the first layer.

In STEP 225, fourth threads of the material are deposited in a second run to complete the second layer (i.e., the second run of the second layer). The fourth threads fill the gaps between the third threads, which create vertical interfaces of the second layer (i.e., second-layer vertical interfaces). The second-layer vertical interfaces may be a point of contact between one end of a third thread and one end of a fourth thread. This way, the second-layer vertical interfaces connect the third and the fourth threads together along a length-wise direction of the third and fourth threads.

In one or more embodiments of the invention, the first-layer vertical interfaces do not overlap with the second-layer vertical interfaces. Alternatively, in other embodiments, some first-layer vertical interfaces may overlap with the second-layer vertical interfaces as a result of design and/or performance constraints.

In one or more embodiments of the invention, the first or second run may include a plurality of runs (i.e., each of the first or second run may be performed more than once). For example, as a result of design, multiple second runs may be performed to put more than one thread to fill a gap between two adjacent threads of the first run.

In one or more embodiments of the invention, each of the first runs or the second runs disclosed in the embodiments of the invention may deposit threads from different material types.

In one or more embodiments of the invention, the deposition may be implemented by a variety of methods including but not limited to Material Jetting, Material Extrusion, Powder Bed Fusion, and Binder Jetting.

In one or more embodiments of the invention, STEPS 205-225 of FIG. 2 discussed above may be executed by a 3D-printer that may be coupled to the system (100). In one or more embodiments, the 3D-printing engine (103) STEPS may cause the 3D-printer to execute the process described in STEPS 210-225.

In one or more embodiments of the invention, although the STEPS 205-225 of FIG. 2 are described with respect to only two layers (i.e., the first layer and the second layer), it would be apparent to one of ordinary skill in the art that the 3D-printed object may include more than two layers and that STEPS 205-225 can be repeated for each of these layers.

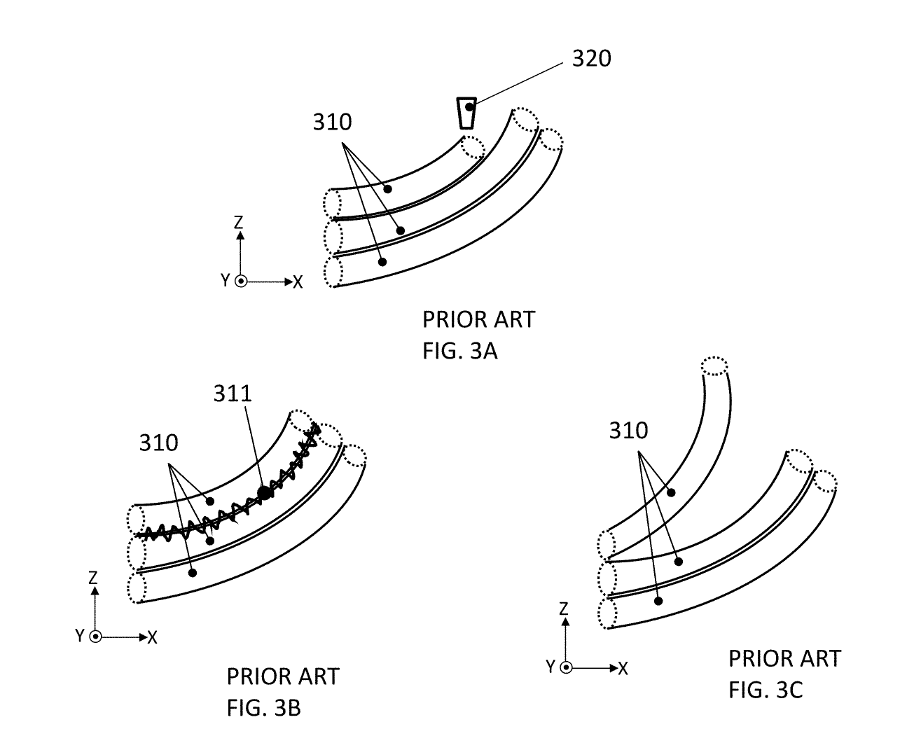

FIGS. 3A-3C show an example of a conventional 3D printing process. In FIG. 3A, each layer (310) is a continuous thread that is deposited by a printing head (320) on top of another layer or a substrate. For simplicity, hereinafter the Z-axis shown in the figures is the direction that the layers (310) stand on top of each other (i.e., the direction that the layers are stacked on top of each other in a vertical direction). Z-axis may be the direction in which the printing head (320) extrudes a material to be deposited.

In view of FIG. 3B, upon an impact of stress (311) on some of the layers (310), because there are no vertical interfaces within each layer, the stress (311) propagates through the entire inter-layer interfaces. As shown in FIG. 3C, because the inter-layer interfaces are weak compared to a solid thread, the stress (311) may cause mechanical failure of the 3D-printed object by peeling one layer (310) off another layer (310). Having inter-layer interfaces and lack of vertical interfaces within each layer makes the mechanical strength of the 3D-printed object very anisotropic (i.e., not uniform in three-dimensions) because there is less mechanical strength along the Z-axis.

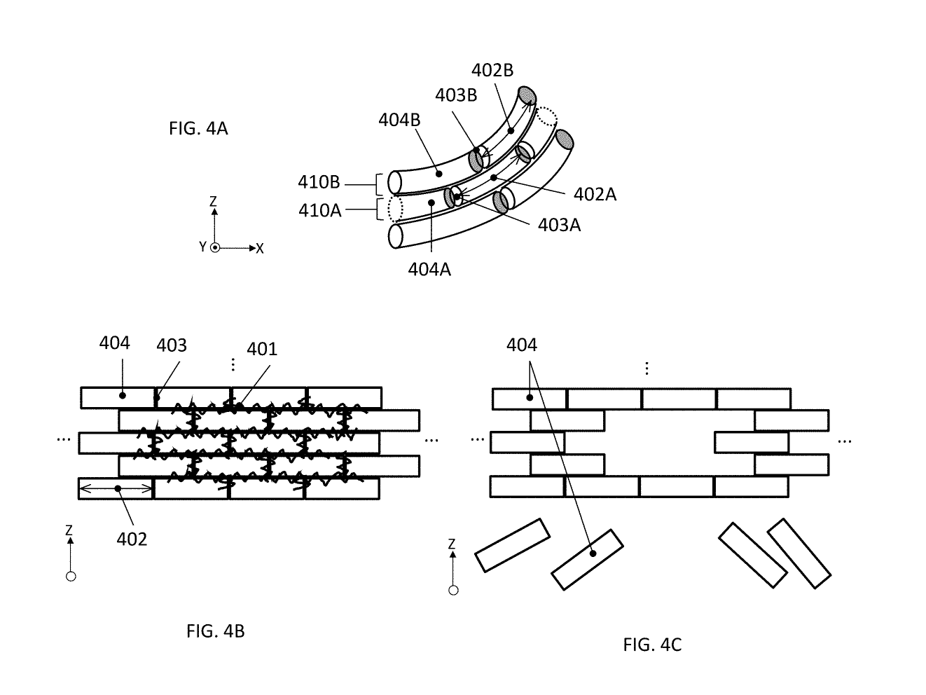

On the other hand, FIGS. 4A-4C, 5-7, and 8A-8B show implementation examples in accordance with one or more embodiments of the invention. The exemplified 3D-printing method described above in reference to FIGS. 1 and 2 are applied in the implementation examples shown in FIGS. 4A-4C, 5-7, and 8A-8B.

Hereinafter, with reference to first layers (410A, 510A, 610A, 710A, 810A) and second layers (410B, 510B, 610B, 710B, 810B) shown in FIGS. 4A, 5-7, and 8A-8B, one or more implementation examples in accordance with one or more embodiments of the invention will be described. These examples can be extended to any layer of a 3D-printed object.

FIG. 4A shows a 3D-illustration of a portion of a 3D-printed object. As seen in FIG. 4A, the first layer (410A) and the second layer (410B) are deposited on top of each other along the Z-axis. Each of the layers has multiple threads (404A, 404B) and multiple vertical interfaces (403A, 403B) that connect the ends of two threads (404A, 404B). The vertical interfaces (403A, 403B) in FIG. 4A are shown as gaps between the threads (404A, 404B) for purposes of illustrations only. The actual 3D-printed object does not include any gaps at the vertical interfaces (403A, 403B).

In one or more embodiments of the invention, the direction along the Z-axis is a direction that connects a thread of adjacent layers (e.g., first layer (410A) and second layer (410B)) of the 3D-printed object. Accordingly, the Z-axis direction may or may not be perpendicular to the plane of the layers (e.g., the first layer (410) or the second layer (420)).

The layers (410A, 410B) are deposited discretely to have vertical interfaces (403A, 403B) that connect the threads (404A, 404B) within each of the layers. The vertical interfaces (403A, 403B) of the layers are disposed to have intervals (402A, 402B) in such a way that the vertical interfaces (403A, 403B) of adjacent layers (410A, 410B) do not overlap. For example, FIG. 4A shows that the vertical interfaces of the first layer (410A) (i.e., the first-layer vertical interfaces (403A)) do not overlap with the vertical interfaces of the second layer (410B) (i.e., the second-layer vertical interfaces (403B)).

In one or more embodiments, the vertical interfaces (403A, 403B) within each of the layers (410A, 410B) extend along the Z-axis direction, which is a different direction from the in-plane extension directions (i.e., in the plane of the layers (410A, 410B)) of the inter-layer interfaces. Therefore, the vertical interfaces (403A, 403B) provide more isotropic mechanical strength (i.e., mechanical strength that is more uniform in three-dimensions) for the 3D-printed object.

In one or more embodiments of the invention, the threads (404A, 404B) may be disposed in such a way that the first-layer vertical interfaces (403A) do not overlap with the second-layer vertical interfaces (403B). This provides better overall mechanical strength for the 3D-printed object. When the first-layer vertical interfaces (403A) do not overlap with the second-layer vertical interfaces (403B), stress along a vertical interface (403A, 403B) will be mitigated or stopped by the threads (404A, 404B) that connect the ends of the vertical interface (403A, 403B). Thus, when a vertical interface (403A, 403B) collapses, the collapse does not propagate in the direction along Z-axis.

In one or more embodiments of the invention, some first-layer vertical interfaces (403A) may overlap with some second-layer vertical interfaces (403B) as a result of design and/or performance constraints.

FIGS. 4B-4C show how vertical interfaces (403) prevent total collapse of a 3D-printed object by localizing the stress (401). When a certain amount of stress (401) is applied to layers that have vertical interfaces (403), the vertical interfaces (403) do not allow the stress (401) to propagate to the threads (404) that are not directly affected by the stress. The threads (404) that are impacted with the stress (401) may collapse locally at their adjacent vertical interfaces (403). Accordingly, as shown in FIG. 4C, upon the collapse of the stressed threads, only a localized part of the 3D-printed object may collapse and the rest of the 3D-printed object will remain in place.

In one or more embodiments of the invention, depositing layers (410A, 410B) with more vertical interfaces (403A, 403B) at smaller intervals (402A, 402B) may better localize the applied stress within the layers (410A, 410B) and further minimize the area of collapse of any of the layers (410A, 410B). The vertical interfaces (403A, 403B) may be periodically disposed at constant intervals (i.e., a length of a thread (404A, 404B) that is a distance between two adjacent vertical interfaces within a layer).

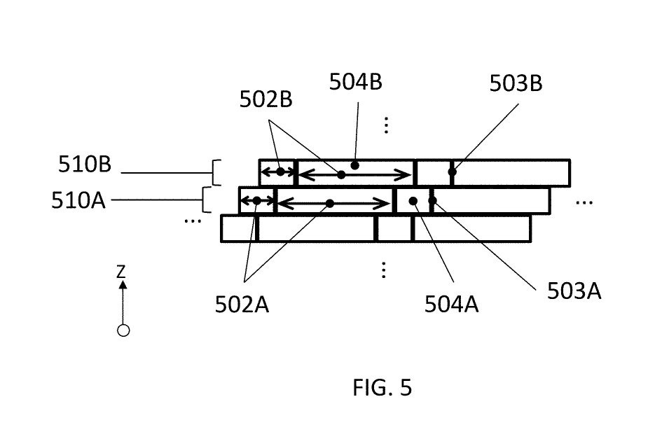

FIG. 5 shows another implementation example in accordance with one or more embodiments of the invention. As shown in FIG. 5, the threads (504A, 504B) of the first layer (510A) and the second layer (510B) may be deposited to have periodic vertical interfaces (503A, 503B) in such a way that each period has multiple intervals (502A, 502B).

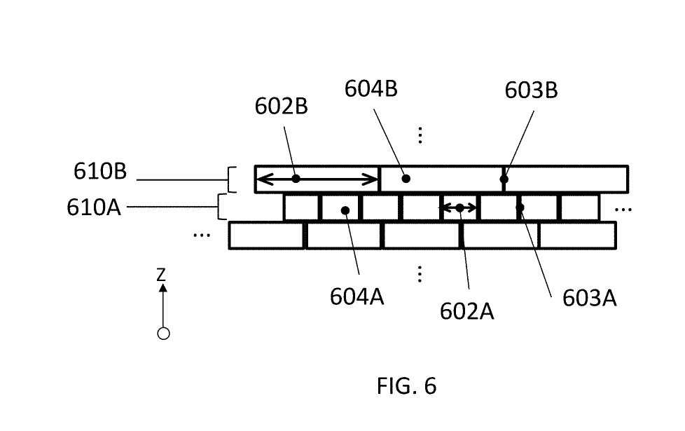

FIG. 6 shows another implementation example in accordance with one or more embodiments of the invention. As shown in FIG. 6, the threads (604A, 604B) of the first layer (610A) and the second layer (610B) may be deposited to have periodic vertical interfaces (603A, 603B) in such a way that the periods of first-layer intervals (602A) are different from the periods of second-layer intervals (602B).

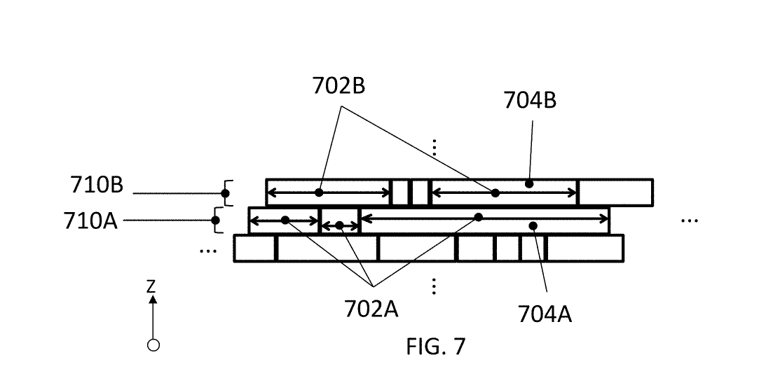

FIG. 7 shows another implementation example in accordance with one or more embodiments of the invention. As shown in FIG. 7, the threads (704A, 704B) of the first layer (710A) and the second layer (710B) may be deposited in such a way that the first-layer intervals (702A) or the second-layer intervals (702B) are irregular (i.e., not periodic).

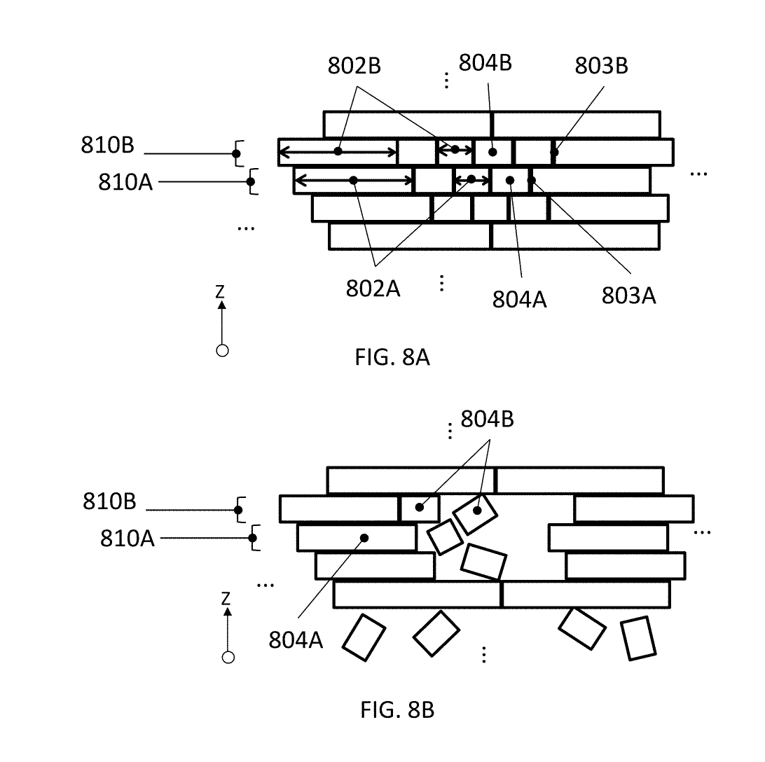

FIGS. 8A-8B show additional implementation examples in accordance with one or more embodiments of the invention. As shown in FIG. 8A, the threads (804A, 804B) of the first layer (810A) or the second layer (810A) may be deposited in such a way that only a part of the first layer (810A) and the second layer (810B) have shorter periodic intervals (802A, 802B) than the rest of the layers (810A, 810B).

Further, as seen in FIG. 8B, collapse of a part of the 3D-printed object, which has shorter intervals (i.e., the short-interval part) than the other parts, prevents collapse of the other parts of the 3D-printed object. When the short-interval part of the 3D-printed object collapses, the shorter intervals localize stress-related delamination of the threads (804A, 804B) in a smaller area around a stress point. Therefore, collapse of a larger part of the 3D-printed object can be prevented.

In accordance with one or more embodiments, the threads (404A, 404B, 504A, 504B, 604A, 604B, 704A, 704B, 804A, 804B) in the first or the second layers may be deposited with a period shown in any combinations described above in reference to FIGS. 4A-4B, 5-7, and 8A-8B.

Embodiments of the invention may be implemented on virtually any type of computing system, regardless of the platform being used. For example, the computing system may be one or more mobile devices (e.g., laptop computer, smart phone, personal digital assistant, tablet computer, or other mobile device), desktop computers, servers, blades in a server chassis, or any other type of computing device or devices that includes at least the minimum processing power, memory, and input and output device(s) to perform one or more embodiments of the invention. For example, the computing system (900) may include one or more computer processor(s) (902), associated memory (904) (e.g., random access memory (RAM), cache memory, flash memory, etc.), one or more storage device(s) (906) (e.g., a hard disk, an optical drive such as a compact disk (CD) drive or digital versatile disk (DVD) drive, a flash memory stick, etc.), and numerous other elements and functionalities. The computer processor(s) (902) may be an integrated circuit for processing instructions. For example, the computer processor(s) may be one or more cores, or micro-cores of a processor. The computing system (900) may also include one or more input device(s) (910), such as a touchscreen, keyboard, mouse, microphone, touchpad, electronic pen, or any other type of input device. Further, the computing system (900) may include one or more output device(s) (908), such as a screen (e.g., a liquid crystal display (LCD), a plasma display, touchscreen, cathode ray tube (CRT) monitor, projector, or other display device), a printer, external storage, or any other output device. One or more of the output device(s) may be the same or different from the input device(s). The computing system (900) may be connected to a network (912) (e.g., a local area network (LAN), a wide area network (WAN) such as the Internet, mobile network, or any other type of network) via a network interface connection (not shown). The input and output device(s) may be locally or remotely (e.g., via the network (912)) connected to the computer processor(s) (902), memory (904), and storage device(s) (906). Many different types of computing systems exist, and the aforementioned input and output device(s) may take other forms.

Software instructions in the form of computer readable program code to perform embodiments of the invention may be stored, in whole or in part, temporarily or permanently, on a non-transitory computer readable medium such as a CD, DVD, storage device, a diskette, a tape, flash memory, physical memory, or any other computer readable storage medium. Specifically, the software instructions may correspond to computer readable program code that when executed by a processor(s), is configured to perform embodiments of the invention.

Further, one or more elements of the aforementioned computing system (900) may be located at a remote location and be connected to the other elements over a network (912). Further, one or more embodiments of the invention may be implemented on a distributed system having a plurality of nodes, where each portion of the invention may be located on a different node within the distributed system. In one embodiment of the invention, the node corresponds to a distinct computing device. Alternatively, the node may correspond to a computer processor with associated physical memory. The node may alternatively correspond to a computer processor or micro-core of a computer processor with shared memory and/or resources.

While the invention has been described with respect to a limited number of embodiments, those skilled in the art, having benefit of this disclosure, will appreciate that other embodiments can be devised which do not depart from the scope of the invention as disclosed herein. Accordingly, the scope of the invention should be limited only by the attached claims.

What is claimed is:

1. A method for manufacturing a three-dimensional printed (3D-printed) object, the method comprising:
depositing first threads separated by gaps in a first run of a first layer;
depositing second threads in a second run of the first layer,
wherein the second threads fill the gaps between the first threads and create a plurality of first-layer vertical interfaces along a length of each of the first threads;
depositing third threads separated by gaps in a first run of a second layer; and
depositing fourth threads in a second run of the second layer,
wherein the fourth threads fill the gaps between the third threads and create a plurality of second-layer vertical interfaces along a length of each of the third threads,
wherein the second layer is deposited on top of the first layer so that one or more of the first-layer vertical interfaces do not overlap with the second-layer vertical interfaces.

2. The method according to claim 1, wherein at least one of the first run of the first layer, the second run of the first layer, the first run of the second layer, and the second run of the second layer is repeated to deposit the respective threads.

3. The method according to claim 1, wherein none of the first-layer vertical interfaces overlap with the second-layer vertical interfaces.

4. The method according to claim 1, wherein the first layer and the second layer are deposited as filaments or powders by a 3D-printer.

5. The method according to claim 1, wherein the method for manufacturing is one selected from a group consisting of: Material Jetting, Material Extrusion, Powder Bed Fusion, and Binder Jetting.

6. The method according to claim 1, wherein at least one of the first-layer vertical interfaces or the second-layer vertical interfaces are periodic.

7. The method according to claim 6, wherein at least one of the periodic first-layer vertical interfaces or the periodic second-layer vertical interfaces have a constant periodic intervals.

8. The method according to claim 6, wherein at least one of the periodic first-layer vertical interfaces or the periodic second-layer vertical interfaces have a plurality of periodic intervals.

9. The method according to claim 6, wherein a period of the first-layer vertical interfaces is different from a period of the second-layer vertical interfaces.

10. A non-transitory computer-readable medium (CRM) storing instructions that causes a print server to perform an operation to manufacture a three-dimensional (3D) object, the operation comprising:
depositing first threads separated by gaps in a first run of a first layer;
depositing second threads in a second run of the first layer,
wherein the second threads fill the gaps between the first threads and create a plurality of first-layer vertical interfaces along a length of each of the first threads;
depositing third threads separated by gaps in a first run of a second layer; and
depositing fourth threads in a second run of the second layer,
wherein the fourth threads fill the gaps between the third threads and create a plurality of second-layer vertical interfaces along a length of each of the third threads,
wherein the second layer is deposited on top of the first layer so that one or more of the first-layer vertical interfaces do not overlap with the second-layer vertical interfaces.

11. The CRM according to claim 10, wherein at least one of the first run of the first layer, the second run of the first layer, the first run of the second layer, and the second run of the second layer is repeated to deposit the respective threads.

12. The CRM according to claim 10, wherein none of the first-layer vertical interfaces overlap with the second-layer vertical interfaces.

13. The CRM according to claim 10, wherein the first layer and the second layer are deposited as filaments or powders by a 3D-printer.

14. The CRM according to claim 10, wherein the method for manufacturing is one selected from a group consisting of: Material Jetting, Material Extrusion, Powder Bed Fusion, and Binder Jetting.

15. A system for three-dimensional (3D) printing of an object, the system comprising:
a memory; and
a computer processor connected to the memory, wherein the computer processor causes a printing head of a 3D-printer coupled to the system to:
deposit first threads separated by gaps in a first run of a first layer;
deposit second threads in a second run of the first layer,
wherein the second threads fill the gaps between the first threads and create a plurality of first-layer vertical interfaces along a length of each of the first threads;
deposit third threads separated by gaps in a first run of a second layer; and
deposit fourth threads in a second run of the second layer,
wherein the fourth threads fill the gaps between the third threads and create a plurality of second-layer vertical interfaces along a length of each of the third threads,
wherein the second layer is deposited on top of the first layer so that one or more of the first-layer vertical interfaces do not overlap with the second-layer vertical interfaces.

16. The system according to claim 15, wherein none of the first-layer vertical interfaces overlap with the second-layer vertical interfaces.

17. The system according to claim 15, wherein at least one of the first-layer vertical interfaces or the second-layer vertical interfaces are periodic.

18. The system according to claim 17, wherein at least one of the periodic first-layer vertical interfaces or the periodic second-layer vertical interfaces have constant periodic intervals.

19. The system according to claim 17, wherein at least one of the periodic first-layer vertical interfaces or the periodic second-layer vertical interfaces have a plurality of periodic intervals.

20. The system according to claim 17, wherein a period of the first-layer vertical interfaces is different from a period of the second-layer vertical interfaces.
